(19) United States
(12) Patent Application Publication
(10) Pub. No.: US 2016/0227903 A1
(43) Pub. Date: Aug. 11, 2016

(54) FOUNDATION CONTAINER HAVING DISCHARGING PUMP HAVING SHORT STROKE DISTANCE AND CONTENT DIFFUSION MEMBER

(71) Applicant: Sungil KANG, Gyeonggi-do (KR)

(72) Inventor: SUNGIL KANG, Seongnam-si (KR)

(21) Appl. No.: 15/024,168

(22) PCT Filed: Sep. 23, 2014
(86) PCT No.: PCT/KR2014/008825

§ 371 Date: Mar. 24, 2016

(30) Foreign Application Priority Data
Sep. 24, 2013 (KR) 20-2013-0007876

(51) Int. Cl. A45D 40/00; B05B 11/00; A45D 40/22

(52) U.S. Cl. CPC A45D 40/0075; A45D 40/22; B05B 11/3025; B05B 11/3045

(57) ABSTRACT

The present invention relates to a foundation container configured by an outer container main body (100) and an outer container lid (150) opened/closed while being hinge-coupled to the outer container main body (100), the foundation container having a discharge pump having a short stroke distance and a content diffusion member, the foundation container comprising: an inner container main body (300) formed inside the outer container main body (100); an auxiliary container (370) formed in the inner container main body (300) and configured to receive contents; an inner container lid (400) for covering the upper portion of the inner container main body (300); an inner container shielding plate (350) inwardly coupled to the upper portion of the inner container main body (300); a discharge pump (600) coupled to the central portion of the inner container shielding plate (350); a content diffusion member (700) coupled to the discharge pump (600); an impregnation member (800) coupled to the upper portion of the content diffusion member (700).

### TECHNICAL FIELD

The present invention relates to a foundation container having a discharge pump having a short stroke distance and a content diffusion member, and more particularly, to a foundation container having a discharge pump having a short stroke distance and a content diffusion member, in which a pump upper body, to which a discharge valve is installed, is vertically reciprocated in a pump main body to change the volume of a content temporary storage space so that the contents are pumped, and a content diffusion member is provided on a top end of the pump upper body such that contents are uniformly diffused in an impregnation member.

### BACKGROUND ART

A compact container keeps powdered contents therein and the powdered contents are used by using a puff. However, when the powdered contents are used, the contents may be scattered. In addition, when the powdered contents are applied on a face, the adhesion is deteriorated. Thus, there has been developed gel-type foundation in order to overcome such defects. Due to the convenience, the gel-type foundation has been increasingly used.

In general, cosmetics are manufactured by mixing mutually different materials having mutually different specific gravity, and the cosmetic materials may be classified into water-in-oil (W/O) emulsion type cosmetic material and oil-in-water (O/W) emulsion type cosmetic material obtained by mixing water-based material and oil-based material such as an emulsifying agent including a surface active agent.

The water-in-oil emulsion type cosmetic material has a larger quantity of oil than that of water and is oily so that the absorption of skin is slow. Although the touch feeling of the water-in-oil emulsion type cosmetic material is heavy, the persistence is longer than that of the oil-in-water emulsion type cosmetic material. The oil-in-water emulsion type cosmetic material has a larger quantity of water than that of oil and is little oily so that the absorption of skin is fast. Although the touch feeling of the water-in-oil emulsion type cosmetic material is flash and light, the persistence is low. Therefore, the cosmetics requiring persistence are manufactured by using the W/O emulsion type cosmetic material to increase water resistance against sweat and water.

Although the touch feeling of the W/O emulsion type cosmetic material is heavy and sticky, the defects may be compensated by reducing the viscosity of content. However, when the water-in-oil product having low viscosity remains for a long time in circulation, the aqueous material of internal phase and the oil materials of external phase may be separated from each other. In this case, a user shakes a container to mix the separated aqueous and oil materials with each other for use, but it is inconvenient to shake the container for use.

To solve the problems, as shown in FIG. 1, there has been disclosed a product in Korean Patent Unexamined Publication No. 10-2013-0001688, where water-in-oil contents having low viscosity are impregnated into an impregnation member to be contained in an airless pump container.

As shown in FIG. 1, the impregnation member 2000 in which the gel-type foundation is impregnated is contained in a container main body 1000. To use the gel-type foundation impregnated into the impregnation member 2000, vacuum pressure is generated in the container main body 1000 through the pumping operation of the airless pump 4000 by pushing a push button 5000 so that a push plate 3000 at a lower portion of the container train body 1000 is lifted up. Thus, the impregnation member 2000 into which the gel-type foundation is impregnated is compressed upward while being diminished by the push plate 3000, so that the gel-type foundation is discharged.

However, since the volume of the impregnation member 2000 is great, it is difficult for the push plate 3000 to fully lift up the impregnation member 2000 only by the pumping operation of the airless pump 4000. Therefore, it is difficult to fully use the gel-type foundation impregnated into the impregnation member 2000, so that the contents are wasted.

Thus, as shown in FIG. 2, to prevent the gel-type foundation from being residual, there has been proposed a compact container having an airless pump in Korean Registered Utility Model No. 20-0461424.

Although the compact container having an airless pump prevents contents from being residual in a container main body 1000 by using the airless pump 4000, since the airless pump of the compact container according to the related art must use an operating piston 4200 and a sealing piston 4300 due to its structure, the stroke distance is long and, when the airless pump is installed in a flat container such as a compact, the airless pump must be manufactured to have a short stroke distance, so that the discharge amount at a time is small, so pumping must be performed several times to obtain a desired amount. In addition the structure of the airless pump 4000 is complex so that the manufacturing cost is increased.

For reference, the structure of the airless pump will be described as follows. As shown in FIGS. 3 and 4, the structure of the airless pump includes an opening/closing part 4120 for opening or closing the content introduction hole 4100 and the operating piston 4200 installed to receive the elastic force of the elastic member 4400. A cylinder is installed in the pump main body 4800 such that the operating piston 4200 presses the content storage room 4500 to allow the contents in the content storage room 4500 to be discharged through the push button 5000.

The sealing piston 4300 is additionally installed to the operating piston 4200 and a push button 5000 is installed to an operating tube 47000 coupled to the operating piston 4200 of the cylinder 4600.

According to the content discharge pump of the related art having the above described configuration, when the push button 500 is pushed, after a pore is first created between the sealing piston 4300 and the operating piston 4200, the sealing piston 4300 and the operating piston 4200 move down together to generate pressure in a content storage room 4500, so that the contents are discharged through a content transfer path 4220 of the operating piston 4200 by the pressure.

In this case, an opening/closing part 4120 is tightly closed to a content introduction hole 4100 by a compressed elastic member 4400 to shut off the content introduction hole 4100.

After the push button 5000 is pushed to discharge the contents as described above, when the pressure on the push button 5000 is removed, as shown in FIG. 4, the operating piston 4200 and the sealing piston 4300 move up together by the repulsive elastic force accumulated in the elastic member 4400.

At the initial raising stage of the operating piston 4200 and the sealing piston 4300 described above, while the sealing piston 4300 is stopped due to the friction of the sealing piston 4300 and the inside of the cylinder 4600, the operating piston 4200 first moves up, so that the pore created between the operating piston 4200 and the sealing piston 4300 is closed, so that the content transfer path 4220 is shut off and the elastic force accumulated in the elastic member 4400 is weakened.

As described above, in the state that the content transfer path 4220 is shut off, as the operating piston 4200 and the sealing piston 4300 continuously move up by the elastic member 4400, vacuum pressure is generated in the content storage room 4500 and the opening/closing part 4120 is spaced apart from the content introduction hole 4100 by the vacuum pressure generated in the content storage room 4500, so that the contents in the container are introduced into the content storage room 4500.

The content discharge pump according to the related art repeats the above-described operation so that the contents are discharged.

However, the structure of the content discharge pump according to the related art is very complex so that the productivity is deteriorated and the product price is increased. In addition, since the stroke distance of the discharge pump is long due to its structure, when the discharge pump is applied to a product such as a compact, the height of which is less than the width thereof, the space in which the discharge pump is installed is small, so that it is difficult to install the discharge pump. When the discharge pump is manufactured in a small size to solve the problem, the discharge amount of contents is too small so that the pumping must be performed several times to obtain a desired amount of contents.

In addition, although the foundation container having an airless pump according to the related art prevents gel-type foundation from being residual therein, the foundation container does not have any foundations of suitably mixing the separated aqueous and oil materials of the gel-type foundation with each other. Thus, it is inconvenient in use because a consumer must shake the foundation container to mix the aqueous and oil materials with each other.

### DISCLOSURE

### Technical Problem

The present invention has been suggested to solve the problems described above, and an object of the present invention is to provide a foundation container easily operated in a short stroke distance pump, which includes a discharge pump having a short stroke distance such that a pump upper body, to which a discharge valve is installed, is vertically reciprocated in a pump main body to change the volume of a content temporary storage space to pump the contents.

In addition, another object of the present invention is to provide a foundation container which includes an impregnation member provided on an upper end of a discharge pump such that the separated aqueous and oil materials are uniformly mixed with each other.

In addition, still another object of the present invention is to provide a foundation container which is capable of uniformly mixing gel-type contents when the gel-type contents are discharged by an impregnation member, so that the foundation container is not required to be shaken for use.

In addition, still another object of the present invention is to provide a foundation container which includes a content diffusion member provided on an upper end of the discharge pump upper body to uniformly diffuse the contents on an impregnation member so that the contents having a uniform concentration may be used.

In addition, still another object of the present invention is to provide a foundation container which is capable of discharging gel-type contents by using a discharge pump so that the contents are prevented from being residual therein and which is capable of fully using the gel-type contents so that the contents are prevented from being wasted.

In addition, still another object of the present invention is to provide a foundation container which includes a discharge pump having a simple structure to be easily manufactured, so that the productivity is improved and the product price is reduced.

### Technical Solution

The present invention provides a foundation container which includes a discharge pump having short stroke distance, a content diffusion member, an outer container main body (100), and an outer container lid (150) hinge-coupled to the outer container main body (100) to be opened or closed, which the foundation container includes:

an inner container main body formed in the outer container main body (100);

a supplementary container (370) formed in the inner container main body (300) to contain contents;

an inner container lid (400) for covering an upper part of the inner container main body (300);

an inner container blocking plate (350) coupled to an upper inside of the inner container main body (300);

the discharge pump (600) coupled to a center of the inner container blocking plate (350);

a content diffusion member (700) coupled to the discharge pump (600); and

an impregnation member (800) coupled to an upper part of the content diffusion member (700),

wherein the discharge pump (600) includes a pump main body (10), a pump upper body (20), a pump lower body (30), an absorption valve plate (40), a discharge valve (50) and an elastic member (60).

When a top surface of the pump upper body (20) or the discharge valve (50) of the discharge pump (600) is pressed to move down the pump upper body (20), a volume of a temporary storage space (TR) is reduced to generate pressure in the temporary storage space (TR) so that the absorption valve plate closes a content absorption hole (32). A valve protrusion wheel (52) tightly closed to a content outlet (22) of an extension protrusion wheel (26) is opened by the pressure so that the contents in the temporary storage space (TR) pass through a gap formed between the content outlet (22) of the extension protrusion wheel (26) and the valve protrusion wheel (52). After the contents pass through a flowing path (24) which is a gap between the pump upper body (20) and the discharge valve (50), a discharge pressure is applied to an upper periphery part of the discharge valve (50) so that a gap is formed between an upper surface of the pump upper body (20) and the upper periphery part of the discharge valve (50) and the contents are discharged through the gap.

When a pressure applied onto the top surface of the pump upper body (20) or the discharge pump (50) is removed, the pump upper body (20) moves up due to restoring force of the elastic member (60) and the temporary storage space (TR) in the pump main body (10) is enlarged so that vacuum pressure is generated to close a gap between the valve protrusion wheel of the discharge valve (50) and the content outlet (22) of the extension protrusion wheel (26). A boundary line of an opening/closing line (41) cracks while a central part of the absorption valve plate (40) is lifted up due to the vacuum pressure so that the contents in the supplementary container (370) are delivered into the temporary storage space (TR) while passing through a gap between the absorption valve plate (40) and the content absorption hole (32). The contents passing through the content absorption hole (32) are delivered into the temporary storage space (TR) through a gap of the opening/closing line (41) of the absorption valve plate (40). When the vacuum pressure in the temporary storage space (TR) is removed due to the moving of the contents, the cracked opening/closing line (41) is restored to an original state thereof and closed due to elastic force of the absorption valve plate (40) so that the absorption valve plate (40) closes the content absorption hole (32).

In addition, the inner container main body (300) may be integrated with the outer container main body (100).

In addition, a sealing ring (360) may be further coupled to an outer peripheral surface of the inner container blocking plate (350) to enhance sealing strength.

In addition, preferably, a fixing member (330) is coupled to an upper side of the inner container main body (300) to prevent the inner container blocking plate (350), the content diffusion member (700) and an impregnation member from being separated from each other.

In addition, the inner container lid (400) may be provided at an upper part thereof with a puff keeping space (410) on which a puff lid (420) is formed.

In addition, preferably, a puff (900) is kept in the puff keeping space (410) of the inner container lid (400).

### Advantageous Effects

According to the foundation container provided with a discharge pump having a short stroke distance and a content diffusion member of the present invention, the pump upper body, to which the discharge valve is installed, is vertically reciprocated in the pump main body to change the volume of the content temporary storage space so that the contents are pumped.

In addition, according to the foundation container of the present invention, the impregnation member is provided on an upper end of a discharge pump such that the separated aqueous and oil materials are uniformly mixed with each other.

In addition, according to the foundation container of the present invention, the gel-type contents may be uniformly mixed with each other when the gel-type contents are discharged by an impregnated member, so that the foundation container may be conveniently used because the foundation container is not required to be shaken for use.

In addition, according to the foundation container of the present invention, the content spreading member is provided on an upper end of the discharge pump to uniformly spread the contents over an impregnated member so that the contents having a uniform concentration may be used.

In addition, according to the foundation container of the present invention, since the discharging gel-type contents is discharged by the discharge pump, the contents may be prevented from being residual therein, so that the gel-type contents may be fully used, thereby preventing the contents from being wasted.

In addition, according to the foundation container of the present invention, since the discharge pump has a simple structure, the discharge pump may be easily manufactured, so that the productivity may be improved and the product price may be reduced.

### DESCRIPTION OF DRAWINGS

FIG. 1 is a sectional view of a cosmetic container having an impregnated member according to the related art.

FIG. 2 is a sectional view showing a compact container having an airless pump according to the related art.

FIG. 3 is an exemplary view showing a state that contents are discharged by operating a content discharge pump according to the related art.

FIG. 4 is an exemplary view showing a state that a content discharge pump is restored to an original state when pressure on the content discharge pump is removed according to the related art.

FIG. 5 is an exploded perspective view of a foundation container according to the present invention.

FIG. 6 is a sectional view showing an entire foundation container according to the present invention.

FIG. 7 is an exploded perspective view of a foundation container according to the present invention.

FIG. 8 is a sectional view showing a discharge pump of a foundation container according to the present invention.

FIG. 9 is a view showing a using state of a foundation container according to the present invention.

FIG. 10 is a view showing a using state of a foundation container according to another embodiment of the present invention.

FIG. 11 is a plan view of a content diffusion member of a foundation container according to the present invention.

FIG. 12 is a sectional view of a content diffusion member of a foundation container according to the present invention.

FIG. 13 is a perspective view of a content diffusion member of a foundation container according to the present invention.

FIG. 14 is a view of a content diffusion member of a foundation container according to another embodiment of the present invention.

### BEST MODE

### Mode for Invention

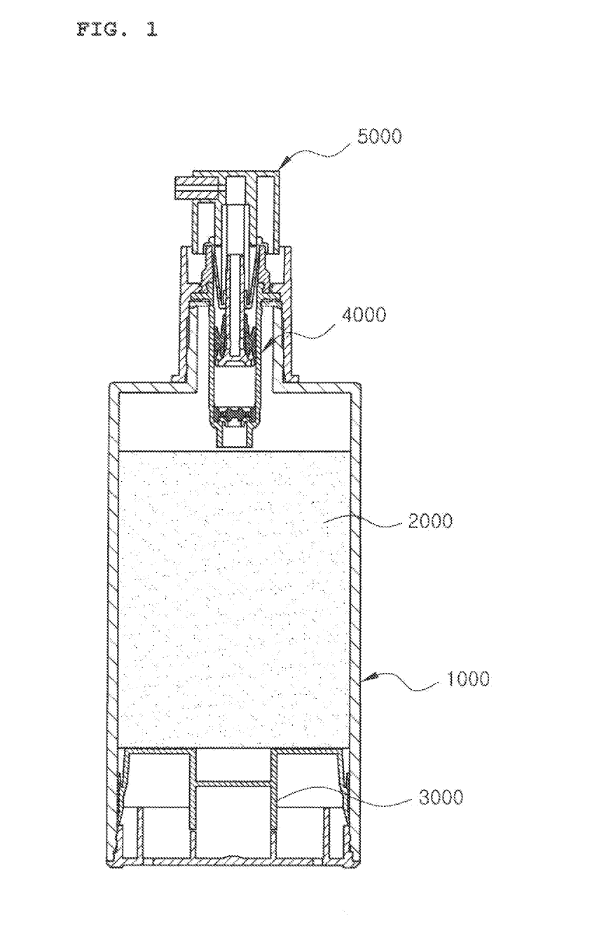

FIG. 1 is a sectional view of a cosmetic container having an impregnated member according to the related art.

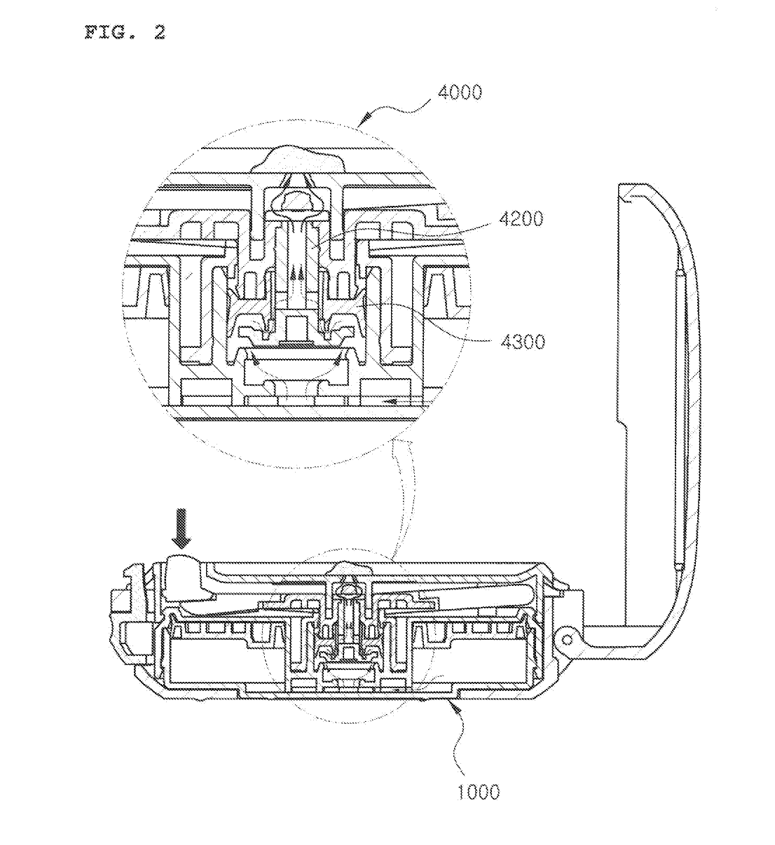

FIG. 2 is a sectional view showing a compact container having an airless pump according to the related art.

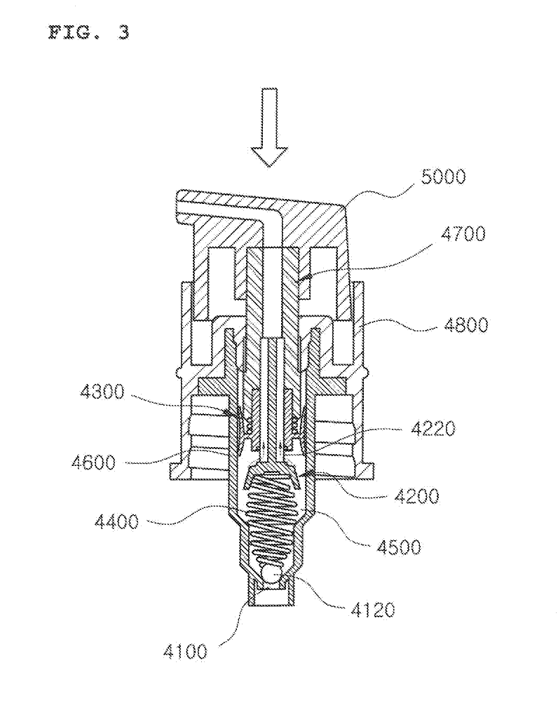

FIG. 3 is an exemplary view showing a state that contents are discharged by operating a content discharge pump according to the related art.

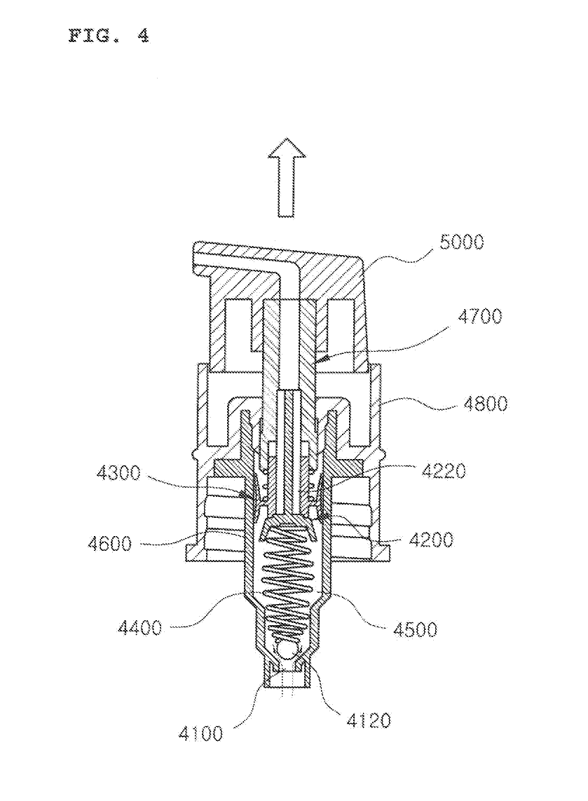

FIG. 4 is an exemplary view showing a state that a content discharge pump is restored to an original state when pressure on the content discharge pump is removed according to the related art.

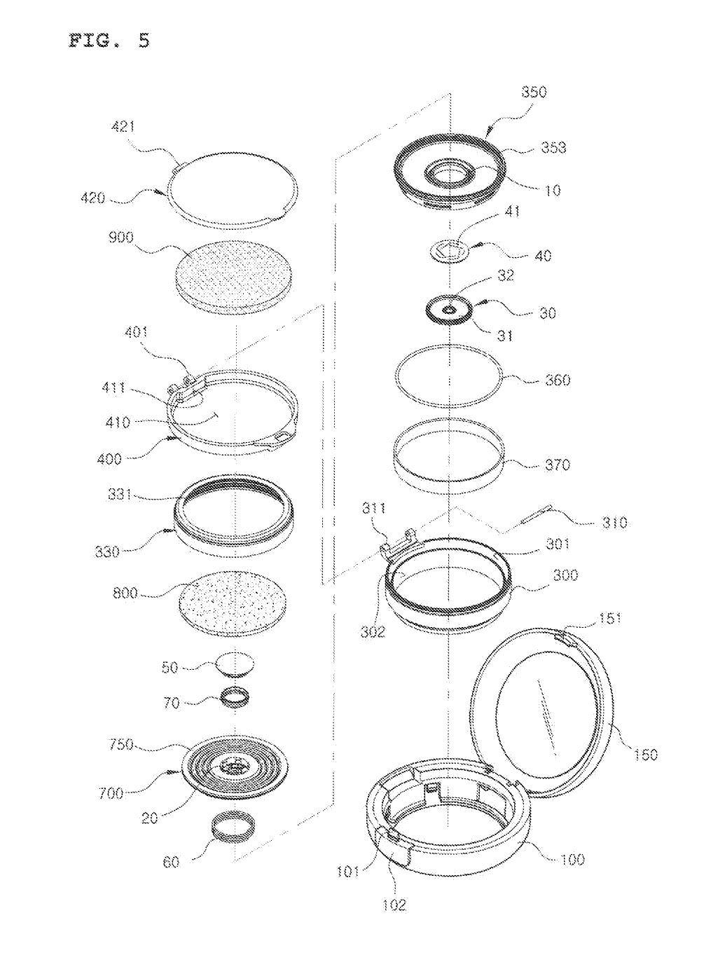

FIG. 5 is an exploded perspective view of a foundation container according to the present invention.

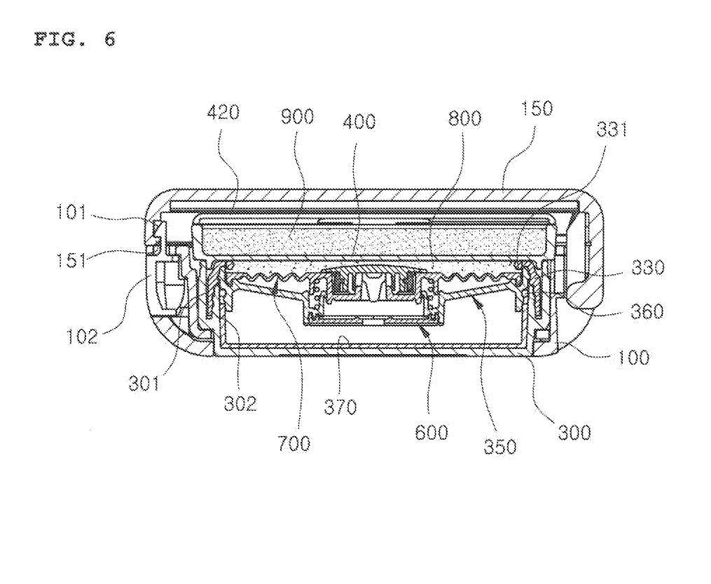

FIG. 6 is a sectional view showing an entire foundation container according to the present invention.

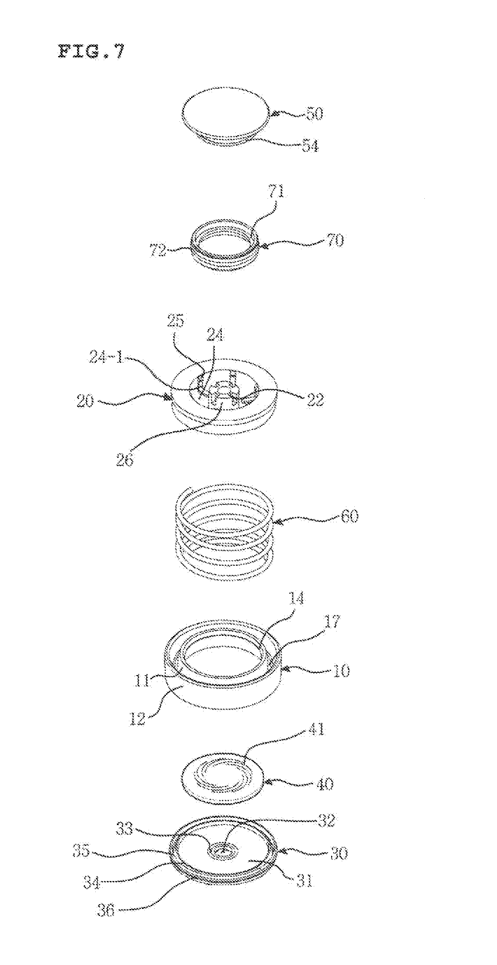

FIG. 7 is an exploded perspective view of a foundation container according to the present invention.

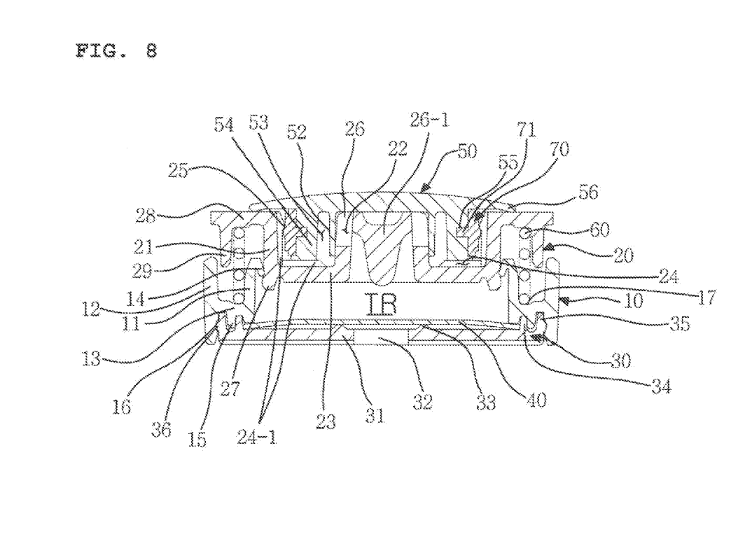

FIG. 8 is a sectional view showing a discharge pump of a foundation container according to the present invention.

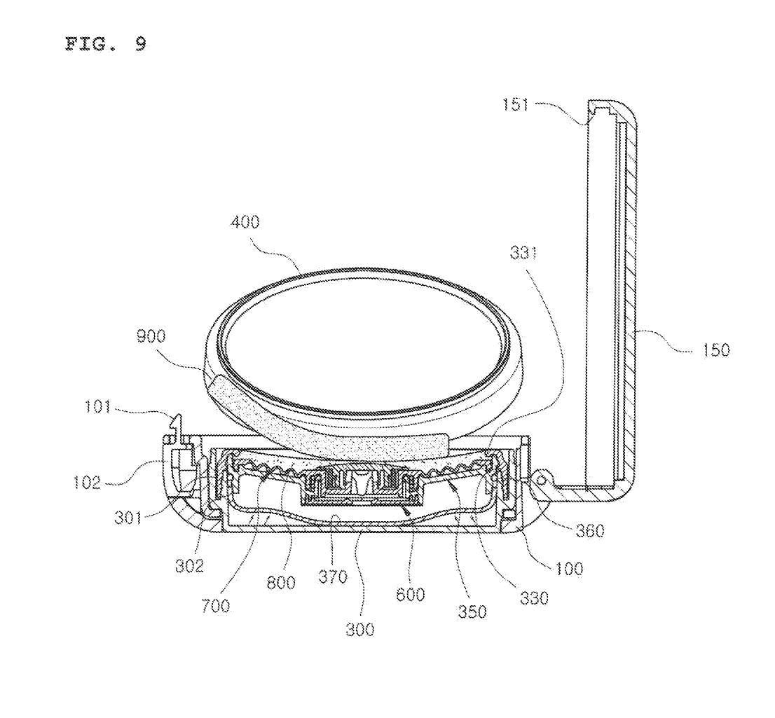

FIG. 9 is a view showing a using state of a foundation container according to the present invention.

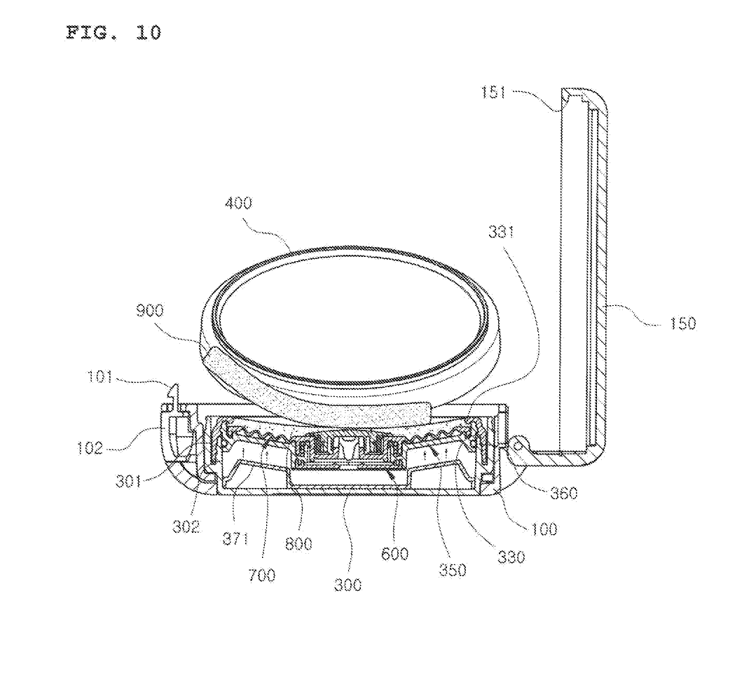

FIG. 10 is a view showing a using state of a foundation container according to another embodiment of the present invention.

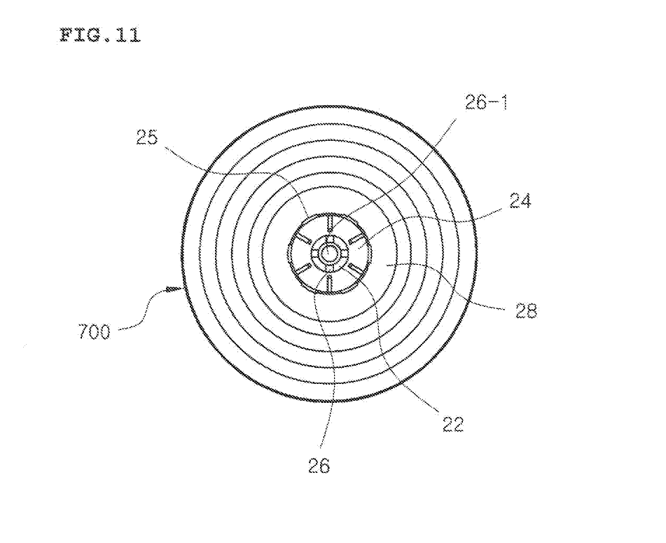

FIG. 11 is a plan view of a content diffusion member of a foundation container according to the present invention.

FIG. 12 is a sectional view of a content diffusion member of a foundation container according to the present invention.

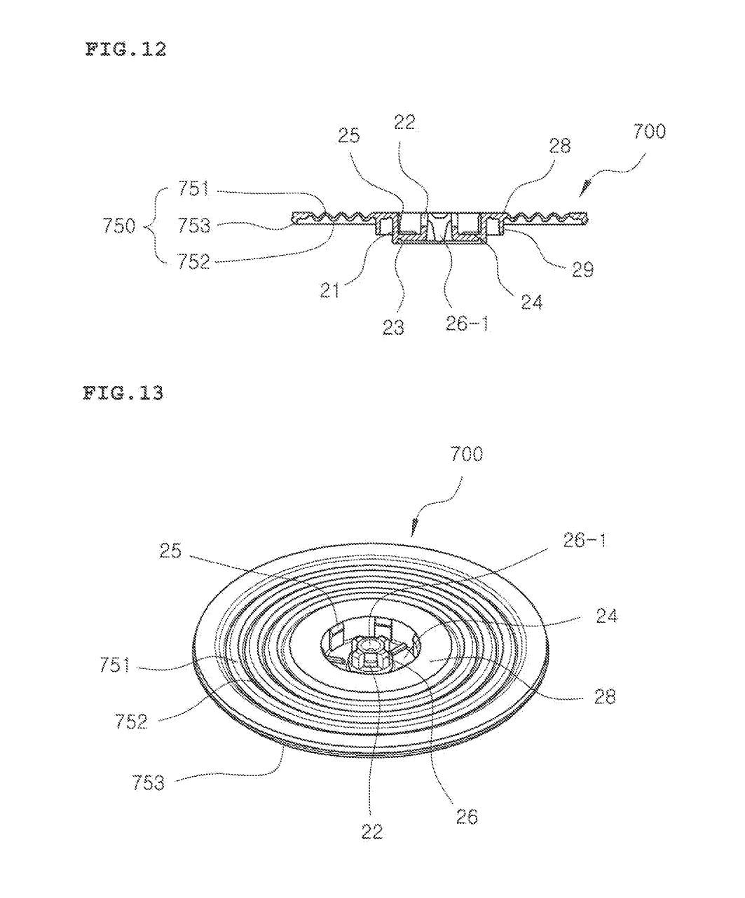

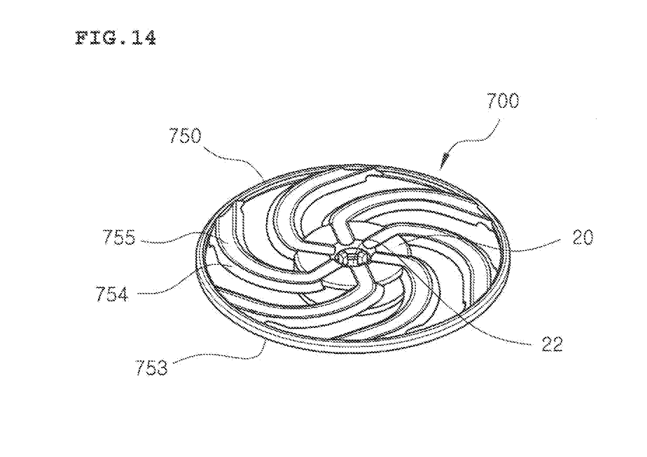

FIG. 13 is a perspective view of a content diffusion member of a foundation container according to the present invention.

FIG. 14 is a view of a content diffusion member of a foundation container according to another embodiment of the present invention

### DESCRIPTION OF REFERENCE NUMERAL

100: Outer container main body
150: Outer container lid
300: Inner container main body
310: Hinge pin
320: Sealing supplementary ring
330: Fixing member
350: Inner container blocking plate
370: Supplementary container
400: Inner container lid
410: Puff keeping space
420: Puff lid
600: Discharge pump
700: Content diffusion member
750: Diffusion plate
800: Impregnation member
900: Puff

1. A foundation container which includes a discharge pump having short stroke distance, a content diffusion member, an outer container main body (100), and an outer container lid (150) hinge-coupled to the outer container main body (100) to be opened or closed, the foundation container comprising:
an inner container main body formed in the outer container main body (100);
a supplementary container (370) formed in the inner container main body (300) to contain contents;
an inner container lid (400) for covering an upper part of the inner container main body (300);
an inner container blocking plate (350) coupled to an upper inside of the inner container main body (300);
the discharge pump (600) coupled to a center of the inner container blocking plate (350);
a content diffusion member (700) coupled to the discharge pump (600); and
an impregnation member (800) coupled to an upper part of the content diffusion member (700),
wherein the discharge pump (600) includes a pump main body (10), a pump upper body (20), a pump lower body (30), an absorption valve plate (40), a discharge valve (50) and an elastic member (60).

2. A foundation container which includes a discharge pump having short stroke distance, a content diffusion member, an outer container main body (100), and an outer container lid (150) hinge-coupled to the outer container main body (100) to be opened or closed, the foundation container comprising:
an inner container main body formed in the outer container main body (100);
a pushing plate (371) installed in the inner container main body (300);
an inner container lid (400) for covering an upper part of the inner container main body (300);
an inner container blocking plate (350) coupled to an upper inside of the inner container main body (300);
the discharge pump (600) coupled to a center of the inner container blocking plate (350);
a content diffusion member (700) coupled to the discharge pump (600); and
an impregnation member (800) coupled to an upper part of the content diffusion member (700),
wherein the discharge pump (600) includes a pump main body (10), a pump upper body (20), a pump lower body (30), an absorption valve plate (40), a discharge valve (50) and an elastic member (60).

3. A foundation container including a discharge pump having short stroke distance and a content diffusion member,
wherein an inner container main body (300) in which a supplementary container (370) is formed is fittingly coupled to an outer container main body (100), contents are injected into the supplementary container (370), an inner container blocking plate (350) is fixed to the inner container main body (300) to seal the inner container main body (300), a discharge pump (600) is formed on a center of the content blocking plate (350), a content diffusion member 9700) is coupled to the discharge pump (600), and an impregnation member (800) is coupled to an upper part of the content diffusion member (700).

4. A foundation container including a discharge pump having short stroke distance and a content diffusion member,
wherein an inner container main body (300) to which a pushing plate (371) is installed is fittingly coupled to an outer container main body (100), contents are injected into the supplementary container (370), an inner container blocking plate (350) is fixed to the inner container main body (300) to seal the inner container main body (300), a discharge pump (600) is formed on a center of the content blocking plate (350), a content diffusion member 9700) is coupled to the discharge pump (600), and an impregnation member (800) is coupled to an upper part of the content diffusion member (700).

5. The foundation container of claim 2,
wherein, when a top surface of the pump upper body (20) or the discharge valve (50) of the discharge pump (600) is pressed to move down the pump upper body (20), a volume of a temporary storage space (TR) is reduced to generate pressure in the temporary storage space (TR) so that the absorption valve plate closes a content absorption hole (32),
wherein a valve protrusion wheel (52) tightly closed to a content outlet (22) of an extension protrusion wheel (26) is opened by the pressure so that the contents in the temporary storage space (TR) pass through a gap formed between the content outlet (22) of the extension protrusion wheel (26) and the valve protrusion wheel (52),
wherein, after the contents pass through a flowing path (24) which is a gap between the pump upper body (20) and the discharge valve (50), a discharge pressure is applied to an upper periphery part of the discharge valve (50) so that a gap is formed between an upper surface of the pump upper body (20) and the upper periphery part of the discharge valve (50) and the contents are discharged through the gap,
wherein, when a pressure applied onto the top surface of the pump upper body (20) or the discharge pump (50) is removed, the pump upper body (20) moves up due to restoring force of the elastic member (60) and the temporary storage space (TR) in the pump main body (10) is enlarged so that vacuum pressure is generated to close a gap between the valve protrusion wheel of the discharge valve (50) and the content outlet (22) of the extension protrusion wheel (26),
wherein a boundary line of an opening/closing line (41) cracks while a central part of the absorption valve plate (40) is lifted up due to the vacuum pressure so that the contents in the supplementary container (370) are delivered into the temporary storage space (TR) while passing through a gap between the absorption valve plate (40) and the content absorption hole (32),
wherein the contents passing through the content absorption hole (32) are delivered into the temporary storage space (TR) through a gap of the opening/closing line (41) of the absorption valve plate (40), and
wherein, when the vacuum pressure in the temporary storage space (TR) is removed due to the moving of the contents, the cracked opening/closing line (41) is restored to an original state thereof and closed due to elastic force of the absorption valve plate (40) so that the absorption valve plate (40) closes the content absorption hole (32).

6. The foundation container of claim 2, wherein the discharge pump (600) includes the pump main body (10), the pump upper body (20), the pump lower body (30), the absorption valve plate (40), the discharge valve (50) and the elastic member (60),
wherein the pump main body (10) has an inner wall (11) configured to form a hollow at a center of the pump main body (10),
wherein a connecting piece (13) is formed outside the inner wall (11),
wherein a bent protrusion wheel (14) is integrally formed on an inner upper side of the inner wall (11),
wherein the pump upper body (20) is provided with a vertical wall (21) which is movable up or down while being fitted with the inner wall (11) of the pump main body (10),
wherein the pump upper body (20) is provided with an extension protrusion wheel (26) which is formed at a center thereof with the content outlet (22),
wherein the vertical wall (21) and the extension protrusion wheel (26) are integrally formed through a lower connecting plate (23),
wherein an upper extension piece (28) extends outward from an upper end of the vertical wall (21),
wherein the pump lower body (30) is fittingly coupled to a lower side of the pump main body (10) and includes a flat-shaped blocking plate (31) formed at a center thereof with the content absorption hole (32),
wherein the absorption valve plate (40) has a flat shape, is coupled between the pump main body (10) and the pump lower body (30), and is provided with plural closing/opening lines (41),
wherein the discharge valve (50) is coupled to an upper part of the pump upper body (20) and is provided with a valve protrusion wheel (52) for opening/closing the content outlet (22) of the pump upper body (20),
wherein a coupling protrusion wheel (54) coupled to the pump upper body (20) is coupled to an outside of the valve protrusion wheel (52) and is provided between the valve protrusion wheel (52) and a coupling protrusion wheel (54) with a space (53), and
wherein the elastic member (60) is placed between the pump main body (10) and the pump upper body (20) to elastically support the pump upper body (20).

7-16. (canceled)

17. The foundation container of claim 2, wherein the inner container blocking plate (350) is provided at a center thereof with the pump main body (10), and provided at an upper end thereof with a coupling groove (353) which is fittingly coupled to a coupling protrusion (753) formed on an end of a diffusion plate (750) of the content diffusion member (700).

18. The foundation container of claim 2, wherein the content diffusion member (700) is coupled to the discharge pump (600) and includes a diffusion plate (750) extending from an upper extension piece (28) of the pump upper body (20).

19. The foundation container of claim 18, wherein the extension plate (750) of the content diffusion member (700) is integrated with the pump upper body (20) of the discharge pump (600).

20. (canceled)

21. The foundation container of claim 18, wherein the diffusion plate (750) includes a protrusion part (751), a concaved groove (752) and a coupling protrusion (753).

22. The foundation container of claim 21, wherein the protrusion part (751) and the concaved groove (752) have a circular shape and are repeatedly formed about the pump upper body (20).

23. The foundation container of claim 18, wherein the diffusion plate (750) extends from an upper extension piece (28) of the pump upper body (20) and a diffusion passage (755) through which contents are diffused is formed on a content passage plate (754).

24. (canceled)
